(19) United States
(12) Patent Application Publication
(10) Pub. No.: US 2025/0211119 A1
(43) Pub. Date: Jun. 26, 2025

(54) TRANSFORMATION CONTROL DEVICE AND POWER CONVERSION DEVICE

(71) Applicant: Hitachi Astemo, Ltd., Hitachinaka-shi, Ibaraki (JP)

(72) Inventors: Kazunari KUROKAWA, Hitachinaka-shi (JP); Yuta NAKAMURA, Hitachinaka-shi (JP); Takami SUZUKI, Hitachinaka-shi (JP); Yoshinori SAGIYA, Hitachinaka-shi (JP); Yuji MIYATA, Hitachinaka-shi (JP)

(21) Appl. No.: 18/844,232

(22) PCT Filed: Mar. 29, 2022
(86) PCT No.: PCT/JP2022/015419

§ 371 Date: Sep. 5, 2024

(51) Int. Cl. H02M 3/158; H02M 1/00

(52) U.S. Cl. CPC H02M 3/1586; H02M 1/0038; H02M 1/0067; H02M 1/0009

(57) ABSTRACT

Provide a transformation control device and a power conversion device capable of suppressing drift of a phase current in a magnetic coupling interleave type chopper circuit. The transformation control device controls the magnetic coupling interleave type chopper circuit and includes a switching frequency setting unit that changes and sets a switching frequency of the magnetic coupling interleave type chopper circuit in a time series manner within a predetermined frequency range, in which the transformation control device generates a transformation gate signal having the switching frequency and outputs the transformation gate signal to the magnetic coupling interleave type chopper circuit.

### CROSS REFERENCE TO RELATED APPLICATIONS

This is the U.S. national stage of application No. PCT/JP2022/015419, filed on Mar. 29, 2022. Priority of which is claimed and incorporated herein by reference.

### TECHNICAL FIELD

The present invention relates to a transformation control device and a power conversion device.

### BACKGROUND ART

Patent Document 1 below discloses a power conversion device that is mounted on a vehicle, which travels using a motor as a power source, and that drives the motor by stepping up a direct current voltage, which is input from a direct current power source, using a multi-phase converter and outputting the direct current voltage to an inverter. The multi-phase converter includes two chopper circuits that are connected in parallel and that have each reactor magnetically coupled, and in which drift of a phase current of each chopper circuit flowing in each reactor is detected with high precision by using one current sensor.

### CITATION LIST

### Patent Document

Patent Document 1: Japanese Patent No. 6949223

### SUMMARY OF INVENTION

### Technical Problem

The multi-phase converter is a transformation circuit called a magnetic coupling interleave type chopper circuit. In the magnetic coupling interleave type chopper circuit, there is a concern that a phase current drift cannot be suppressed when a travel motor load current ripple frequency and a gate pulse repetition frequency (a carrier frequency), which controls the multi-phase converter, are synchronized. As a result, there is a concern that the controllability of the magnetic coupling interleave type chopper circuit may be deteriorated and abnormal heat generation of devices in the magnetic coupling interleave type chopper circuit may be caused.

The present invention has been made in view of the above-mentioned circumstances, and an object of the present invention is to provide a transformation control device and a power conversion device capable of suppressing drift of a phase current in a magnetic coupling interleave type chopper circuit.

### Solution to Problem

A transformation control device of a first aspect according to the present disclosure is a transformation control device that controls a magnetic coupling interleave type chopper circuit, the transformation control device includes: a switching frequency setting unit configured to change a switching frequency of the magnetic coupling interleave type chopper circuit in a time series manner within a predetermined frequency range, in which the transformation control device generates a transformation gate signal having the switching frequency and outputs the transformation gate signal to the magnetic coupling interleave type chopper circuit.

In the transformation control device of a second aspect according to the present disclosure, the switching frequency setting unit may randomly change the switching frequency.

In the transformation control device of a third aspect according to the present disclosure, the switching frequency setting unit may set the switching frequency based on a state quantity of the magnetic coupling interleave type chopper circuit.

In the transformation control device of a fourth aspect according to the present disclosure, the transformation control device may acquire a reactor current of each phase by using a single current sensor and set the switching frequency based on the reactor current. In the transformation control device of a fifth aspect according to the present disclosure, the current sensor may detect the reactor current such that current-conduction directions are the same direction.

In the transformation control device of a sixth aspect according to the present disclosure, the switching frequency setting unit may set the switching frequency such that each phase of the magnetic coupling interleave type chopper circuit has the same frequency.

A power conversion device of a seventh aspect according to the present disclosure includes: the transformation control device according to any one of the first to sixth aspects; the magnetic coupling interleave type chopper circuit configured to be controlled by the transformation control device; a drive inverter configured to be provided between the magnetic coupling interleave type chopper circuit and a motor, convert direct current power, which is input from the magnetic coupling interleave type chopper circuit, into alternating current power, and output the alternating current power to the motor; and a power generation inverter configured to be provided between the magnetic coupling interleave type chopper circuit and a power generator, convert alternating current power, which is input from the power generator, into direct current power, and output the direct current power to the magnetic coupling interleave type chopper circuit.

### Advantageous Effects of Invention

According to the present disclosure, it is possible to provide a transformation control device and a power conversion device capable of suppressing drift of a phase current in a magnetic coupling interleave type chopper circuit.

### BRIEF DESCRIPTION OF DRAWINGS

FIG. 1 is a block diagram showing a configuration of a power conversion device A according to an embodiment of the present disclosure.

FIG. 2 is a block diagram showing a configuration of a transformation control device B according to the embodiment of the present disclosure.

FIG. 3 is a characteristic diagram showing a change in carrier frequency in the embodiment of the present disclosure.

FIG. 4 is a waveform diagram showing a detection current in the embodiment of the present disclosure.

FIG. 5A is a first waveform diagram showing an operation of a buck-boost converter (a magnetic coupling interleave type chopper circuit) in the embodiment of the present disclosure.

FIG. 5B is a second waveform diagram showing an operation of the buck-boost converter (the magnetic coupling interleave type chopper circuit) in the embodiment of the present disclosure.

FIG. 6 is a flowchart showing an operation of the transformation control device B according to the embodiment of the present disclosure.

### DESCRIPTION OF EMBODIMENTS

Hereinafter, an embodiment of the present invention will be described with reference to the drawings.

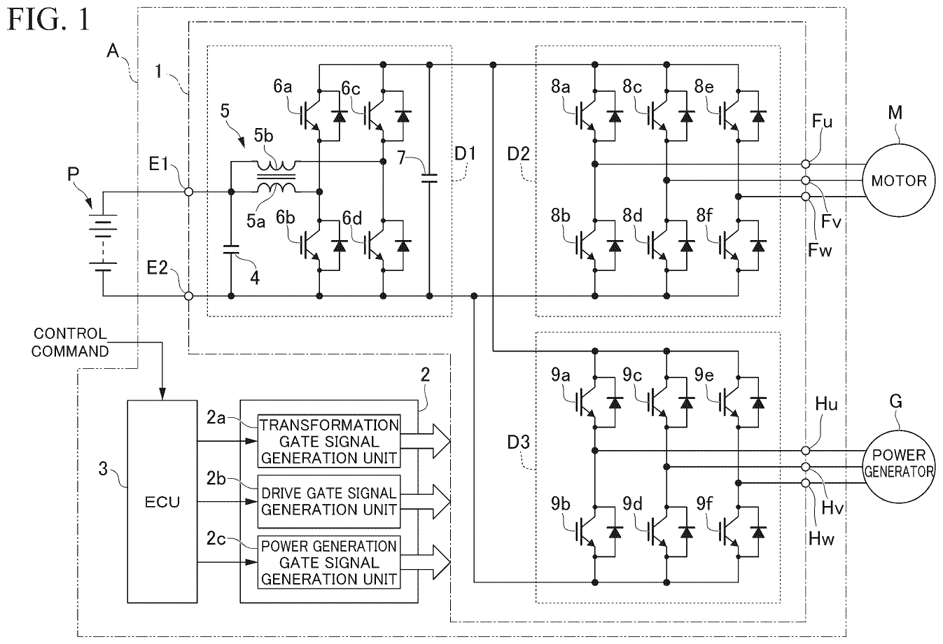

First, a functional configuration of a power conversion device A in the present embodiment will be described with reference to FIG. 1. As shown in the figure, the power conversion device A is provided between a battery P and both a traveling motor M and a three-phase power generator G and performs conversion between the battery power (direct current power) of the battery P and the alternating current power of the traveling motor M and the three-phase power generator G.

The power conversion device A is a power control unit (PCU) that is mounted in an electric vehicle such as a hybrid car or an electric car and performs driving the traveling motor M based on the direct current power of the battery P, charging the battery P with regenerative power (alternating current power) of the traveling motor M, or charging the battery P with generated power (alternating current power) of the three-phase power generator G.

As shown in the figure, the power conversion device A includes a power conversion circuit 1, a gate driver 2, and an electronic control unit (ECU) 3. Further, as shown in the figure, the gate driver 2 includes a transformation gate signal generation unit 2a, a drive gate signal generation unit 2b, and a power generation gate signal generation unit 2c. As shown in the figure, the power conversion circuit 1 includes a buck-boost converter D1, a drive inverter D2, and a power generation inverter D3.

Although the details will be described later, the ECU 3 includes a transformation control unit B that controls the buck-boost converter D1 through the transformation gate signal generation unit 2a and a drive control unit that controls the drive inverter D2 through the drive gate signal generation unit 2b, as functional components. Further, the ECU 3 includes a power generation control unit that controls the power generation inverter D3 through the power generation gate signal generation unit 2c as a functional component.
In the power conversion device A, the transformation gate signal generation unit 2a, the buck-boost converter D1, and the transformation control unit B of the ECU 3 configure a transformation device that power-converts the direct current power and the alternating current power between the battery P, and the traveling motor M and the power generator G. Further, the transformation gate signal generation unit 2a and the transformation control unit B of the ECU 3 configure a transformation control device that controls the buck-boost converter D1 of the power conversion circuit 1.

The power conversion device A includes a pair of battery terminals E1 and E2, three motor terminals Fu, Fv, and Fw, and three power generator terminals Hu, Hv, and Hw, as external connection terminals. Among the pair of the battery terminals E1 and E2, the first battery terminal E1 is connected to a positive electrode of the battery P, and the second battery terminal E2 is connected to a negative electrode of the battery P.

Among the three motor terminals Fu, Fv, and Fw, the first motor terminal Fu is connected to a U-phase terminal of the traveling motor M. The second motor terminal Fv is connected to a V-phase terminal of the traveling motor M. The third motor terminal Fw is connected to a W-phase terminal of the traveling motor M.

Among the three power generator terminals Hu, Hv, and Hw, the first power generator terminal Hu is connected to a U-phase terminal of the power generator G. The second power generator terminal Hv is connected to a V-phase terminal of the power generator G. The third power generator terminal Hw is connected to a W-phase terminal of the power generator G.

In the battery P, the positive electrode is connected to the first battery terminal E1 and the negative electrode is connected to the second battery terminal E2. The battery P is a secondary battery such as a lithium ion battery and performs supplying (discharging) direct current power to the power conversion circuit 1 of the power conversion device A and charging the direct current power through the power conversion circuit 1.

The traveling motor M is a rotary electric machine that is connected to the power conversion device A. The traveling motor M is a three-phase electric machine having three phases and is a load of the power conversion circuit 1. In the traveling motor M, the U-phase terminal is connected to the first motor terminal Fu, the V-phase terminal is connected to the second motor terminal Fv, and the W-phase terminal is connected to the third motor terminal Fw.

In the traveling motor M, a rotation shaft (a drive shaft) is connected to wheels of the electric vehicle, and the wheels are rotationally driven by applying rotational power to the wheels. The traveling motor M generates the regenerative power (the alternating current power) at the time of braking of the electric vehicle, and the regenerative power is input to the power conversion device A through the first motor terminal Fu, the second motor terminal Fv, and the third motor terminal Fw, is converted into direct current power, and is charged into the battery P.

The power generator G is a rotary electric machine that is connected to the power conversion device A. The power generator G is a three-phase power generator of which the U-phase terminal is connected to the first power generator terminal Hu, the V-phase terminal is connected to the second power generator terminal Hv, and the W-phase terminal is connected to the third power generator terminal Hw. The power generator G is connected to an output shaft of a power source, such as an engine that is mounted on the electric vehicle and outputs the generated power (the alternating current power) to the power conversion circuit 1.

The buck-boost converter D1 includes a first capacitor 4, a transformer 5, four transformation insulated gate bipolar transistors (IGBT) 6a to 6d, a second capacitor 7, and a reactor current sensor J. The drive inverter D2 includes six drive IGBTs 8a to 8f. The power generation inverter D3 includes six power generation IGBTs 9a to 9f.

The buck-boost converter D1 is a magnetic coupling interleave type chopper circuit in the present disclosure. The magnetic coupling interleave type chopper circuit is also called a magnetic coupling type multi-phase converter, in which two chopper circuits having different operation phases are connected in parallel, and each of the reactors is magnetically coupled. The buck-boost converter D1 is controlled by the transformation gate signal generation unit 2a to selectively perform a step-up process (a step-up operation) and a step-down process (a step-down operation).

The step-up process (the step-up operation) is a process (an operation) for stepping up the battery power (the direct current power), which is input from the pair of battery terminals E1 and E2 and outputting the battery power to the drive inverter D2. The step-down process (the step-down operation) is a process (an operation) for stepping down the direct current power, which is input from the drive inverter D2 or the power generation inverter D3, and outputting the direct current power from the pair of battery terminals E1 and E2 to the battery P. That is, the buck-boost converter D1 is a power conversion circuit that bidirectionally inputs and outputs the direct current power between the battery P, and the drive inverter D2 or the power generation inverter D3.

The drive inverter D2 includes three switching legs that are provided three in correspondence with the number of phases (three phases) of the traveling motor M. The three switching legs are a U-phase drive switching leg, a V-phase drive switching leg, and a W-phase drive switching leg. The drive inverter D2 is a power conversion circuit that alternatively performs a powering operation and a regenerative operation.

The powering operation is an operation in which the direct current power, which is input from the buck-boost converter D1, is converted into three-phase alternating current power and the alternating current power is output from the three motor terminals Fu, Fv, and Fw to the traveling motor M. The regenerative operation is an operation in which the regenerative power (the alternating current power), which is input to the three motor terminals Fu, Fv, and Fw, is converted into direct current power and the direct current power is output to the buck-boost converter D1. The drive inverter D2 is a power circuit that mutually converts the direct current power and the three-phase alternating current power between the buck-boost converter D1 and the traveling motor M.

The power generation inverter D3 is a power conversion circuit that converts the generated power (the alternating current power), which is input to the three power generator terminals Hu, Hv, and Hw, into direct current power and outputs the direct current power to the buck-boost converter D1. The power generation inverter D3 is a power circuit that mutually converts the direct current power and the three-phase alternating current power between the buck-boost converter D1 and the power generator G.

The configurations of each of the buck-boost converter D1, the drive inverter D2, and the power generation inverter D3 will be described in more detail. In the buck-boost converter D1, in the first capacitor 4, one end is connected to the first battery terminal E1 and the transformer 5, and the other end is connected to the second battery terminal E2. Both ends of the first capacitor 4 are primary side terminals of the buck-boost converter D1.

That is, the first capacitor 4 is connected in parallel to the battery P and removes high frequency noise included in the battery power (the direct current power) input from the battery P to the buck-boost converter D1. Further, the first capacitor 4 smooths a ripple included in the charging power (the direct current power) input from the transformer 5.

The transformer 5 includes a primary winding 5a and a secondary winding 5b. One end of the primary winding 5a and one end of the secondary winding 5b are connected to the first battery terminal E1 and one end of the first capacitor 4. The other end of the primary winding 5a is connected to an emitter terminal of the first transformation IGBT 6a and a collector terminal of the second transformation IGBT 6b. Further, the other end of the secondary winding 5b is connected to an emitter terminal of the third transformation IGBT 6c and a collector terminal of the fourth transformation IGBT 6d.

The primary winding 5a and the secondary winding 5b configure the transformer 5 in a state of being electromagnetically coupled with a predetermined coupling coefficient k. That is, the primary winding 5a has a first self-inductance La according to the number of turns of the primary winding 5a or the like. On the other hand, the secondary winding 5b has a second self-inductance Lb according to the number of turns of the secondary winding 5b or the like. Furthermore, the primary winding 5a and the secondary winding 5b have mutual inductance based on the first self-inductance La, the second self-inductance Lb, and the coupling coefficient k described above.

Among the four transformation IGBTs 6a to 6d, the first transformation IGBT 6a and the second transformation IGBT 6b are semiconductor switching elements configuring an A-phase transformation switching leg in the buck-boost converter D1. Further, the third transformation IGBT 6c and the fourth transformation IGBT 6d are semiconductor switching elements configuring a B-phase switching leg in the buck-boost converter D1.

In the first transformation IGBT 6a, a collector terminal is connected to a collector terminal of the third transformation IGBT 6c and one end of the second capacitor 7, and the emitter terminal is connected to the other end of the primary winding 5a of the transformer 5 and the collector terminal of the second transformation IGBT 6b. Further, in the first transformation IGBT 6a, a gate terminal is connected to a first output terminal for the buck-boost converter D1 of the gate driver 2. In the first transformation IGBT 6a, an ON/OFF operation is controlled based on a first transformation gate signal that is input from the transformation gate signal generation unit 2a of the gate driver 2.

In the second transformation IGBT 6b, the collector terminal is connected to the other end of the primary winding 5a of the transformer 5 and the emitter terminal of the first transformation IGBT 6a, and an emitter terminal is connected to the emitter terminal of the fourth transformation IGBT 6d, the other end of the first capacitor 4, and the other end of the second capacitor 7. Further, in the second transformation IGBT 6b, a gate terminal is connected to a second output terminal for the buck-boost converter D1 in the gate driver 2. In the second transformation IGBT 6b, an ON/OFF operation is controlled based on a second transformation gate signal that is input from the transformation gate signal generation unit 2a of the gate driver 2.

In the third transformation IGBT 6c, a collector terminal is connected to the collector terminal of the first transformation IGBT 6a and one end of the second capacitor 7, and the emitter terminal is connected to the other end of the secondary winding 5b of the transformer 5 and the collector terminal of the fourth transformation IGBT 6d. Further, in the third transformation IGBT 6c, a gate terminal is connected to a third output terminal for the buck-boost converter D1 in the gate driver 2. In the third transformation IGBT 6c, an ON/OFF operation is controlled based on a third transformation gate signal that is input from the transformation gate signal generation unit 2a of the gate driver 2.

In the fourth transformation IGBT 6d, the collector terminal is connected to the other end of the secondary winding 5b of the transformer 5 and an emitter terminal of the third transformation IGBT 6c, and the emitter terminal is connected to the emitter terminal of the second transformation IGBT 6b, the other end of the first capacitor 4, and the other end of the second capacitor 7. Further, in the fourth transformation IGBT 6d, a gate terminal is connected to a fourth output terminal for the buck-boost converter D1 in the gate driver 2. In the fourth transformation IGBT 6d, an ON/OFF operation is controlled based on a fourth transformation gate signal that is input from the transformation gate signal generation unit 2a of the gate driver 2.

Further, in the second capacitor 7, one end is connected to the collector terminal of the first transformation IGBT 6a and the collector terminal of the third transformation IGBT 6c, and the other end is connected to the emitter terminal of the second transformation IGBT 6b, the emitter terminal of the fourth transformation IGBT 6d, the other end of the first capacitor 4, and the second battery terminal E2. The both ends of the second capacitor 7 are secondary side input and output terminals in the buck-boost converter D1.

The second capacitor 7 smooths a ripple included in the step-up power (the direct current power) input from the A-phase transformation switching leg and the B-phase transformation switching leg above described. Further, the second capacitor 7 smooths ripples included in the regenerative power (the direct current power) input from the drive inverter D2 and the charging power (the direct current power) input from the power generation inverter D3.

The reactor current sensor J is a detector that detects a state quantity of the buck-boost converter D1. The reactor current sensor J is engaged with the primary winding 5a and the secondary winding 5b of the transformer 5 such that current-conduction directions are the same direction and detects, as a reactor current I_{L}, a total current of the A-phase current of the buck-boost converter D1 flowing through the primary winding 5a and the B-phase current of the buck-boost converter D1 flowing through the secondary winding 5b.

The A-phase current is a current that flows through the primary winding 5a based on the A-phase transformation switching leg of the buck-boost converter D1, that is, the switching operations of the first transformation IGBT 6a and the second transformation IGBT 6b. The B-phase current is a current that flows through the secondary winding 5b based on the B-phase switching leg of the buck-boost converter D1, that is, the switching operations of the third transformation IGBT 6c and the fourth transformation IGBT 6d.

The reactor current sensor J outputs the reactor current I_{L}, which is the total current of the A-phase current and the B-phase current, to the ECU 3 as one of the control information. Further, the reactor current I_{L} is a powering current which flows from the primary side to the secondary side, a regenerative current which flows from the secondary side to the primary side, or a charging current which flows from the secondary side to the primary side, in the buck-boost converter D1.

Although not shown in FIG. 1, the buck-boost converter D1 is provided with a primary side voltage sensor and a secondary side voltage sensor in addition to the current sensor J, as detectors that detect the state quantity of the buck-boost converter D1. The primary side voltage sensor is a voltage sensor that detects a primary voltage Vp (a direct current voltage) on a primary side of the buck-boost converter D1, that is, on the battery P side, and outputs the primary voltage Vp to the ECU 3.

The secondary side voltage sensor is a voltage sensor that detects a secondary voltage Vs (a direct current voltage) on a secondary side of the buck-boost converter D1, that is, on the drive inverter D2 side (the power generation inverter D3 side), and outputs the secondary voltage Vs to the ECU 3. The secondary voltage Vs is the primary voltage in the drive inverter D2 and is the secondary voltage of the power generation inverter D3.

Subsequently, the drive inverter D2 will be described. The drive inverter D2 is provided between the buck-boost converter D1, which is a transformation circuit, and the traveling motor M and is an inverter circuit that converts the direct current power, which is input from the buck-boost converter D1 (the transformation circuit), into the alternating current power to drive the traveling motor M.

Among the six drive IGBTs 8a to 8f configuring the drive inverter D2, the first drive IGBT 8a and the second drive IGBT 8b are semiconductor switching elements configuring a U-phase drive switching leg. Further, the third drive IGBT 8c and the fourth drive IGBT 8d are semiconductor switching elements configuring a V-phase drive switching leg. Further, the fifth drive IGBT 8e and the sixth drive IGBT 8f are semiconductor switching elements configuring a W-phase drive switching leg.

Among the first drive IGBT 8a and the second drive IGBT 8b, in the first drive IGBT 8a, a collector terminal is connected to a collector terminal of the third drive IGBT 8c and a collector terminal of the fifth drive IGBT 8e. Further, in the first drive IGBT 8a, an emitter terminal is connected to a collector terminal of the second drive IGBT 8b and the first motor terminal Fu.

Further, in the first drive IGBT 8a, a gate terminal is connected to a first output terminal for the drive inverter D2 in the gate driver 2. In the first drive IGBT 8a, an ON/OFF operation is controlled based on a first drive gate signal that is input from the drive gate signal generation unit 2b of the gate driver 2.

In the second drive IGBT 8b, a collector terminal is connected to the emitter terminal of the first drive IGBT 8a and the first motor terminal Fu, and an emitter terminal is connected to an emitter terminal of the fourth drive IGBT 8d and an emitter terminal of the sixth drive IGBT 8f.

Further, in the second drive IGBT 8b, a gate terminal is connected to a second output terminal for the drive inverter D2 in the gate driver 2. In the second drive IGBT 8b, an ON/OFF operation is controlled based on a second drive gate signal that is input from the drive gate signal generation unit 2b of the gate driver 2.

In the third drive IGBT 8c, the collector terminal is connected to the collector terminal of the first drive IGBT 8a and the collector terminal of the fifth drive IGBT 8e, and an emitter terminal is connected to the collector terminal of the fourth drive IGBT 8d and the second motor terminal Fv.

Further, in the third drive IGBT 8c, a gate terminal is connected to a second output terminal for the drive inverter D2 in the gate driver 2. In the third drive IGBT 8c, an ON/OFF operation is controlled based on a third drive gate signal that is input from the drive gate signal generation unit 2b of the gate driver 2.

In the fourth drive IGBT 8d, the collector terminal is connected to the emitter terminal of the third drive IGBT 8c and the second motor terminal Fv, and the emitter terminal is connected to the emitter terminal of the second drive IGBT 8b and the emitter terminal of the sixth drive IGBT 8f.

Further, in the fourth drive IGBT 8d, a gate terminal is connected to a fourth output terminal for the drive inverter D2 in the gate driver 2. In the fourth drive IGBT 8d, an ON/OFF operation is controlled based on a fourth drive gate signal that is input from the drive gate signal generation unit 2b of the gate driver 2.

In the fifth drive IGBT 8e, the collector terminal is connected to the collector terminal of the first drive IGBT 8a and the third drive IGBT 8c, and the emitter terminal is connected to the collector terminal of the sixth drive IGBT 8f and the third motor terminal Fw.

Further, in the fifth drive IGBT 8e, a gate terminal is connected to a fifth output terminal for the drive inverter D2 in the gate driver 2. In the fifth drive IGBT 8e, an ON/OFF operation is controlled based on a fifth drive gate signal that is input from the drive gate signal generation unit 2b of the gate driver 2.

In the sixth drive IGBT 8f, the collector terminal is connected to the emitter terminal of the fifth drive IGBT 8e and the third motor terminal Fw, and the emitter terminal is connected to the emitter terminal of the second drive IGBT 8b and the emitter terminal of the fourth drive IGBT 8d.

Further, in the sixth drive IGBT 8f, a gate terminal is connected to a sixth output terminal for the drive inverter D2 in the gate driver 2. In the sixth drive IGBT 8f, an ON/OFF operation is controlled based on a sixth drive gate signal that is input from the drive gate signal generation unit 2b of the gate driver 2.

In the drive inverter D2, both ends of the U-phase drive switching leg, the V-phase drive switching leg, and the W-phase drive switching leg, which are commonly connected to each other, are primary side input and output terminals of the drive inverter D2. Three middle points of the U-phase drive switching leg, the V-phase drive switching leg, and the W-phase drive switching leg are each a secondary side input and output terminal of the drive inverter D2.

That is, a connection point between the emitter terminal of the first drive IGBT 8a and the collector terminal of the second drive IGBT 8b, a connection point between the emitter terminal of the third drive IGBT 8c and the collector terminal of the fourth drive IGBT 8d, and a connection point between the emitter terminal of the fifth drive IGBT 8e and the collector terminal of the sixth drive IGBT 8f are the middle points, which are the secondary side input and output terminals of the drive inverter D2.

One of the primary side input and output terminals of drive inverter D2, that is, the collector terminal of the first drive IGBT 8a, the collector terminal of the third drive IGBT 8c, and the collector terminal of the fifth drive IGBT 8e are connected to one of the secondary side input and output terminals in the buck-boost converter D1, that is, one end of the second capacitor 7, the collector terminal of the first transformation IGBT 6a, and the collector terminal of the third transformation IGBT 6c.

The other of the primary side input and output terminals of drive inverter D2, that is, the emitter terminal of the second drive IGBT 8b, the emitter terminal of the fourth drive IGBT 8d, and the emitter terminal of the sixth drive IGBT 8f are connected to the other of the secondary side input and output terminals in the buck-boost converter D1, that is, the other ends of the first and second capacitors 4 and 7, the emitter terminal of the second transformation IGBT 6b, and the emitter terminal of the fourth transformation IGBT 6d.

Subsequently, the power generation inverter D3 will be described. The power generation inverter D3 is provided between the buck-boost converter D1, which is a transformation circuit, and the power generator G and is an inverter circuit that converts the generated power (the alternating current power), which is input from the power generator G, into direct current power and outputs the direct current power to the buck-boost converter D1 (the transformation circuit).

Among the six power generation IGBTs 9a to 9f configuring the power generation inverter D3, the first power generation IGBT 9a and the second power generation IGBT 9b are semiconductor switching elements configuring a U-phase power generation switching leg. The third power generation IGBT 9c and the fourth power generation IGBT 9d are semiconductor switching elements configuring the V-phase power generation switching leg. The fifth power generation IGBT 9e and the sixth power generation IGBT 9f are semiconductor switching elements configuring the W-phase power generation switching leg.

Among the first power generation IGBT 9a and the second power generation IGBT 9b, in the first power generation IGBT 9a, a collector terminal is connected to a collector terminal of the third power generation IGBT 9c and a collector terminal of the fifth power generation IGBT 9e, and an emitter terminal is connected to a collector terminal of the second power generation IGBT 9b and the first power generator terminal Hu.

In the first power generation IGBT 9a, a gate terminal is connected to a first output terminal for the power generation inverter D3 in the gate driver 2. In the first power generation IGBT 9a, an ON/OFF operation is controlled based on a first power generation gate signal that is input from the power generation gate signal generation unit 2c of the gate driver 2.

In the second power generation IGBT 9b, a collector terminal is connected to the emitter terminal of the first power generation IGBT 9a and the first power generator terminal Hu, and an emitter terminal is connected to an emitter terminal of the fourth power generation IGBT 9d and an emitter terminal of the sixth power generation IGBT 9f. In the second power generation IGBT 9b, a gate terminal is connected to a second output terminal for the power generation inverter D3 in the gate driver 2. In the second power generation IGBT 9b, an ON/OFF operation is controlled based on a second power generation gate signal that is input from the power generation gate signal generation unit 2c of the gate driver 2.

In the third power generation IGBT 9c, the collector terminal is connected to the collector terminal of the first power generation IGBT 9a and the collector terminal of the fifth power generation IGBT 9e, and an emitter terminal is connected to the collector terminal of the fourth power generation IGBT 9d and the second power generator terminal Hv. In the third power generation IGBT 9c, a gate terminal is connected to a third output terminal for the power generation inverter D3 in the gate driver 2. In the third power generation IGBT 9c, an ON/OFF operation is controlled based on a third power generation gate signal that is input from the power generation gate signal generation unit 2c of the gate driver 2.

In the fourth power generation IGBT 9d, the collector terminal is connected to the emitter terminal of the third power generation IGBT 9c and the second power generator terminal Hv, and the emitter terminal is connected to the emitter terminal of the second power generation IGBT 9b and the emitter terminal of the sixth power generation IGBT 9f. In the fourth power generation IGBT 9d, a gate terminal is connected to a fourth output terminal for the power generation inverter D3 in the gate driver 2. In the fourth power generation IGBT 9d, an ON/OFF operation is controlled based on a fourth power generation gate signal that is input from the power generation gate signal generation unit 2c of the gate driver 2.

In the fifth power generation IGBT 9e, the collector terminal is connected to the collector terminal of the first power generation IGBT 9a and the collector terminal of the third power generation IGBT 9c. An emitter terminal is connected to the collector terminal of the sixth power generation IGBT 9f and the third power generator terminal Hw. In the fifth power generation IGBT 9e, a gate terminal is connected to a fifth output terminal for the power generation inverter D3 in the gate driver 2. In the fifth power generation IGBT 9e, an ON/OFF operation is controlled based on a fifth power generation gate signal that is input from the power generation gate signal generation unit 2c of the gate driver 2.

In the sixth power generation IGBT 9f, the collector terminal is connected to the emitter terminal of the fifth power generation IGBT 9e and the third power generator terminal Hw, and the emitter terminal is connected to the emitter terminal of the second power generation IGBT 9b and the emitter terminal of the fourth power generation IGBT 9d. In the sixth power generation IGBT 9f, a gate terminal is connected to a sixth output terminal for the power generation inverter D3 in the gate driver 2. In the sixth power generation IGBT 9f, an ON/OFF operation is controlled based on a sixth power generation gate signal that is input from the power generation gate signal generation unit 2c of the gate driver 2.

In the power generation inverter D3, three middle points of the U-phase power generation switching leg, the V-phase power generation switching leg, and the W-phase power generation switching leg are primary side input and output terminals of the power generation inverter D3. That is, a connection point between the emitter terminal of the first power generation IGBT 9a and the collector terminal of the second power generation IGBT 9b, a connection point between the emitter terminal of the third power generation IGBT 9c and the collector terminal of the fourth power generation IGBT 9d, and a connection point between the emitter terminal of the fifth power generation IGBT 9e and the collector terminal of the sixth power generation IGBT 9f are the middle points, which are the primary side input and output terminals of the power generation inverter D3.

Among the three primary side input and output terminals in the power generation inverter D3, the middle point (the first primary side input and output terminal) of the U-phase power generation switching leg is connected to the first power generator terminal Hu in the power conversion device A. The middle point (the second primary side input and output terminal) of the V-phase power generation switching leg is connected to the second power generator terminal Hv in the power conversion device A. The middle point (the third primary side input and output terminal) of the W-phase power generation switching leg is connected to the third power generator terminal Hw in the power conversion device A.

Both ends of the U-phase power generation switching leg, the V-phase power generation switching leg, and the W-phase power generation switching leg, which are connected in parallel to each other in the power generation inverter D3, are secondary side input and output terminals in the power generation inverter D3. That is, the collector terminal of the first power generation IGBT 9a, the collector terminal of the third power generation IGBT 9c, the collector terminal of the fifth power generation IGBT 9e, the emitter terminal of the second power generation IGBT 9b, the emitter terminal of the fourth power generation IGBT 9d, and the emitter terminal of the sixth power generation IGBT 9f are the secondary side input and output terminals.

As shown in the figure, the secondary side input and output terminal of the power generation inverter D3 is connected to the secondary side input and output terminal of the buck-boost converter D1 and the primary side input and output terminal of the drive inverter D2. That is, the power generation inverter D3 performs the input and output of the direct current power with the buck-boost converter D1.

Further, each of the transformation IGBTs 6a to 6d of the buck-boost converter D1, the drive IGBT 8a to 8f of the drive inverter D2, and the power generation IGBT 9a to 9f of the power generation inverter D3 includes a reflux diode. In these reflux diodes, a cathode terminal is connected to a collector terminal, and an anode terminal is connected to an emitter terminal, for each of the IGBTs. The reflux diode is for allowing a reflux current to flow from the anode terminal to the cathode terminal at the time when the IGBT is in an OFF state.

Subsequently, the gate driver 2 will be described. The gate driver 2 drives the buck-boost converter D1, the drive inverter D2, and the power generation inverter D3 based on a plurality of duty command values (a transformation duty manipulation amount, a drive duty manipulation amount, and a power generation duty manipulation amount) input from the ECU 3.

That is, the transformation gate signal generation unit 2a is a drive circuit of the buck-boost converter D1 and is a drive signal generation circuit that generates the first to fourth transformation gate signals based on various voltage transformation manipulation amounts input from the ECU 3. The transformation gate signal generation unit 2a generates pulse width modulation (PWM) signals having a repetition frequency and a duty ratio in accordance with a transformation carrier frequency and the transformation duty manipulation amount as the first to fourth transformation gate signals by comparing the transformation duty manipulation amount with a carrier wave (a triangular wave) with a period corresponding to the transformation carrier frequency, for example.

The transformation gate signal generation unit 2a outputs the first transformation gate signal from the first output terminal for the buck-boost converter D1 to the gate terminal of the first transformation IGBT 6a. The transformation gate signal generation unit 2a outputs the second transformation gate signal from the second output terminal for the buck-boost converter D1 to the gate terminal of the second transformation IGBT 6b. The transformation gate signal generation unit 2a outputs the third transformation gate signal from the third output terminal for the buck-boost converter D1 to the gate terminal of the third transformation IGBT 6c. The transformation gate signal generation unit 2a outputs the fourth transformation gate signal from the fourth output terminal for the buck-boost converter D1 to the gate terminal of the fourth transformation IGBT 6d.

Here, among the first to fourth transformation gate signals, the first and second transformation gate signals are gate pulse signals (PWM signals) that drive the A-phase transformation switching leg (the first transformation IGBT 6a and the second transformation IGBT 6b) of the buck-boost converter D1. Further, the third and fourth transformation gate signals are gate pulse signals (PWM signals) that drive the B-phase transformation switching leg (the third transformation IGBT 6c and the fourth transformation IGBT 6d) of the buck-boost converter D1.

The first and second transformation gate signals and the third and fourth transformation gate signals are different in phase by, for example, 180 degrees around switching, that is, the A-phase transformation switching leg (the first transformation IGBT 6a and the second transformation IGBT 6b), which is driven by the first and second transformation gate signals, and the B-phase transformation switching leg (the third transformation IGBT 6c and the fourth transformation IGBT 6d), which is driven by the third and fourth transformation gate signals, perform a switching operation with a phase difference of, for example, 180°.

The drive gate signal generation unit 2b is a drive circuit of the drive inverter D2 and is a drive signal generation circuit that generates the first to sixth drive gate signals based on the drive duty manipulation amount that is input from the ECU 3. The drive gate signal generation unit 2b generates PWM signals having a repetition frequency (a repetition period) and a duty ratio in accordance with a drive carrier frequency and the drive duty manipulation amount as the first to sixth drive gate signals by comparing the drive duty manipulation amount with a carrier wave (a triangular wave) with a period corresponding to the drive carrier frequency, for example.

The drive gate signal generation unit 2b outputs the first drive gate signal from the first output terminal for the drive inverter D2 to the gate terminal of the first drive IGBT 8a. The drive gate signal generation unit 2b outputs the second drive gate signal from the second output terminal for the drive inverter D2 to the gate terminal of the second drive IGBT 8b. The drive gate signal generation unit 2b outputs the third drive gate signal from the third output terminal for the drive inverter D2 to the gate terminal of the third drive IGBT 8c.

The drive gate signal generation unit 2b outputs the fourth drive gate signal from the fourth output terminal for the drive inverter D2 to the gate terminal of the fourth drive IGBT 8d. The drive gate signal generation unit 2b outputs the fifth drive gate signal from the fifth output terminal for the drive inverter D2 to the gate terminal of the fifth drive IGBT 8e. The drive gate signal generation unit 2b outputs the sixth drive gate signal from the sixth output terminal for the drive inverter D2 to the gate terminal of the sixth drive IGBT 8f.

The power generation gate signal generation unit 2c is a drive circuit of the power generation inverter D3 and is a drive signal generation circuit that generates the first to sixth power generation gate signals based on the power generation duty manipulation amount that is input from the ECU 3. The power generation gate signal generation unit 2c generates PWM signals having a repetition frequency and a duty ratio in accordance with a power generation carrier frequency and the power generation duty command value as the first to sixth power generation gate signals by comparing the power generation duty manipulation amount with a carrier wave (a triangular wave) with a period corresponding to the power generation carrier frequency, for example.

The power generation gate signal generation unit 2c outputs the first power generation gate signal from the first output terminal for the power generation inverter D3 to the gate terminal of the first power generation IGBT 9a. The power generation gate signal generation unit 2c outputs the second power generation gate signal from the second output terminal for the power generation inverter D3 to the gate terminal of the second power generation IGBT 9b. The power generation gate signal generation unit 2c outputs the third power generation gate signal from the third output terminal for the power generation inverter D3 to the gate terminal of the third power generation IGBT 9c.

The power generation gate signal generation unit 2c outputs the fourth power generation gate signal from the fourth output terminal for the power generation inverter D3 to the gate terminal of the fourth power generation IGBT 9d. The power generation gate signal generation unit 2c outputs the fifth power generation gate signal from the fifth output terminal for the power generation inverter D3 to the gate terminal of the fifth power generation IGBT 9e. The power generation gate signal generation unit 2c outputs the sixth power generation gate signal from the sixth output terminal for the power generation inverter D3 to the gate terminal of the sixth power generation IGBT 9f.

The first to fourth transformation gate signals, which are generated by the transformation gate signal generation unit 2a, are drive signals provided with a well-known dead time, in order to avoid through currents in the A-phase transformation switching leg and the B-phase switching leg of the buck-boost converter D1.

The first to sixth drive gate signals, which are generated by the drive gate signal generation unit 2b, are drive signals provided with a well-known dead time, in order to avoid through currents in the U-phase drive switching leg, the V-phase drive switching leg, and the W-phase drive switching leg.

The first to sixth power generation gate signals, which are generated by the power generation gate signal generation unit 2c, are drive signals provided with a well-known dead time, in order to avoid through currents in the U-phase power generation switching leg, the V-phase power generation switching leg, and the W-phase power generation switching leg.

The ECU 3 is a control device that performs feedback control of the buck-boost converter D1, the drive inverter D2, and the power generation inverter D3 based on detection values of the various voltage sensors mentioned above (voltage detection values), detection values of various current sensors (current detection values), a control command input from an upper level control device (a vehicle control device), and a control program stored in advance.

That is, the ECU 3 is a software control device that performs feedback control of the buck-boost converter D1, the drive inverter D2, and the power generation inverter D3 with the cooperation of control programs (software resources) and hardware resources such as arithmetic circuits, memory circuits, and various input and output circuits.

The ECU 3 includes a plurality of functional components configured with the cooperation of the software resources and the hardware resources. That is, the ECU 3 includes the transformation control unit B for the buck-boost converter D1, which generates the transformation duty command value, the drive control unit for the drive inverter D2, which generates the drive duty command value, and the power generation control unit for the power generation inverter D3, which generates the power generation duty command value, as the functional components described above.

The ECU 3 generates the first to fourth transformation gate signals by outputting the transformation duty command value, which is generated by the transformation control unit B, to the transformation gate signal generation unit 2a of the gate driver 2. The ECU 3 generates the first to sixth drive gate signals by outputting the drive duty command value, which is generated by the drive control unit, to the drive gate signal generation unit 2b of the gate driver 2. The ECU 3 generates the first to sixth power generation gate signals by outputting the power generation duty command value, which is generated by the power generation control unit, to the power generation gate signal generation unit 2c of the gate driver 2.

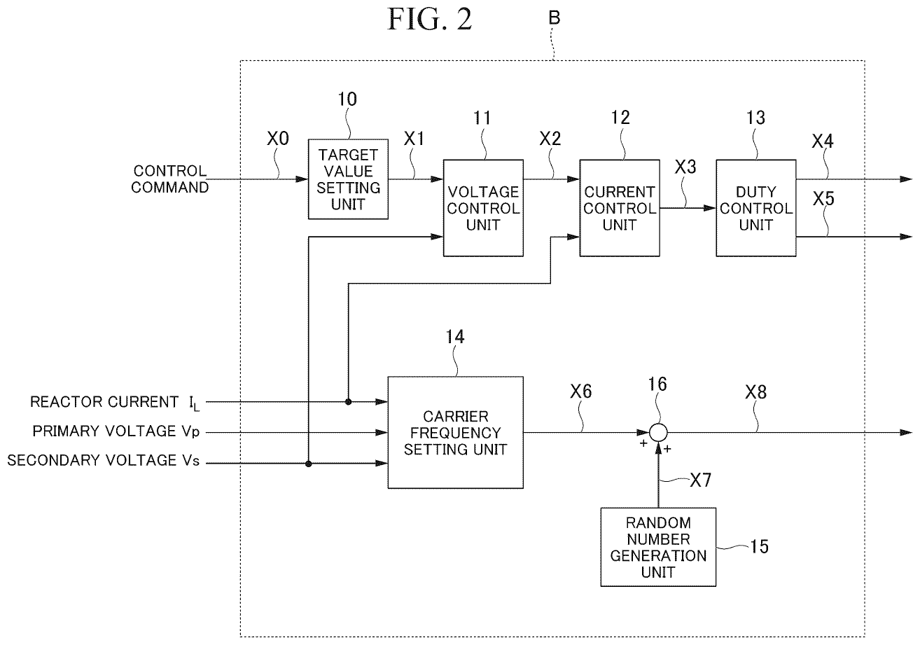

Subsequently, a detailed configuration (a control configuration) of a transformation control unit B in the ECU 3 will be described with reference to FIG. 2. The transformation control unit B is a characteristic functional component of the power conversion device A according to the present embodiment and configures the transformation control device together with the transformation gate signal generation unit 2a.

That is, the transformation control device according to the present embodiment is configured with the transformation control unit B and the transformation gate signal generation unit 2a and controls the buck-boost converter D1 (the magnetic coupling interleave type chopper circuit), which is a transformation circuit. In the ECU 3, the drive control unit and the power generation control unit, other than the transformation control unit B, are substantially the same as those well known, and the description of the detailed configuration (the control configuration) thereof will be omitted.

As shown in FIG. 2, the transformation control unit B includes a target value setting unit 10, a voltage control unit 11, a current control unit 12, a duty control unit 13, a carrier frequency setting unit 14, a random number generation unit 15, and an adder 16, as the components. Among these components, the carrier frequency setting unit 14, the random number generation unit 15, and the adder 16 configure a switching frequency setting unit in the present invention.

The target value setting unit 10 is a functional component that generates a secondary side voltage command value X1 based on a control command X0 input from the outside. The secondary side voltage command value X1 is a target value (a transformation target value) of the secondary voltage Vs of the buck-boost converter D1.

That is, the secondary side voltage command value X1 is a value for designating a transformation ratio of the buck-boost converter D1, that is, the magnitude of the secondary voltage Vs with respect to the primary voltage Vp.

The target value setting unit 10 outputs the secondary side voltage command value X1 to the voltage control unit 11. The control command X0 is a control command that is input from the upper level control device (the vehicle control device). The primary voltage Vp is a detection value of the primary side voltage sensor that is provided on the primary side (the battery P side) of the buck-boost converter D1. The secondary voltage Vs is a detection value of the secondary side voltage sensor that is provided on the secondary side (the drive inverter D2 side) of the buck-boost converter D1.

The voltage control unit 11 is a functional component that calculates a reactor current command value X2 based on the secondary side voltage command value X1 and the secondary voltage Vs. The voltage control unit 11 is a well-known PID controller. More specifically, the voltage control unit 11 includes a proportional voltage control unit, which generates a proportional reactor current command value, and an integral voltage control unit, which generates an integral reactor current command value.

The proportional voltage control unit generates the proportional reactor current command value by multiplying a difference between the voltage command value X1 and the secondary voltage Vs by a proportional voltage gain. The integral voltage control unit generates the integral reactor current command value by multiplying a difference between the voltage command value X1 and the secondary voltage Vs by an integral voltage gain and performing an integral process. The reactor current command value X2 is a sum of the proportional reactor current command value and the integral reactor current command value. The voltage control unit 11 outputs the reactor current command value X2 to the current control unit 12.

The current control unit 12 is a functional component that calculates a reactor voltage command value X3 based on the reactor current command value X2 and the reactor current I_{L}. The current control unit 12 is a well-known PID controller as in the voltage control unit 11. That is, the current control unit 12 includes a proportional current control unit, which generates a proportional reactor voltage command value, and an integral current control unit, which generates an integral reactor voltage command value.

The proportional current control unit generates the proportional reactor voltage command value by multiplying a difference between the current command value X2 and the reactor current I_{L} by a proportional current gain. The integral current control unit generates the integral reactor voltage command value by multiplying a difference between the current command value X2 and the reactor current I_{L} by an integral current gain and performing the integral process. The reactor voltage command value X3 is a sum of the proportional reactor voltage command value and the integral reactor voltage command value. The current control unit 12 outputs the reactor voltage command value X3 to the duty control unit 13.

The duty control unit 13 is a functional component that calculates an A-phase duty command value X4 for the A-phase transformation switching leg and a B-phase duty command value X5 for the B-phase transformation switching leg, based on the reactor voltage command value X3. The duty control unit 13 outputs the A-phase duty command value X4 and the B-phase duty command value X5 to the transformation gate signal generation unit 2a of the gate driver 2.

As described above, the buck-boost converter D1 includes the A-phase transformation switching leg and the B-phase switching leg. The A-phase transformation switching leg and the B-phase switching leg are controlled by the first and second transformation gate signals and the third and fourth transformation gate signals, of which a phase relationship differs by 180 degrees.

The duty control unit 13 generates the A-phase duty command value X4 and the B-phase duty command value X5, in order to correspond to such a two-phase configuration of the buck-boost converter D1. That is, the A-phase duty command value X4 is a manipulation amount for designating a duty ratio of the first transformation gate signal and the second transformation gate signal, which control the A-phase transformation switching leg. Further, the B-phase duty command value X5 is a manipulation amount for designating a duty ratio of the third transformation gate signal and the fourth transformation gate signal, which control the B-phase transformation switching leg.

The carrier frequency setting unit 14 is a functional component that sets a carrier frequency fc (kHz) based on the primary voltage Vp, the secondary voltage Vs, and the reactor current I_{L}. The carrier frequencies fc are repetition frequencies of the first to fourth transformation gate signals, that is, repetition frequencies of switching operations in the A-phase transformation switching leg and the B-phase transformation switching leg. The carrier frequency fc is any frequency in a frequency range of, for example, 6 to 12 kHz.

The carrier frequency setting unit 14 sets the carrier frequency fc by searching for a carrier map (a three-dimensional map) stored inside in advance based on the primary voltage Vp, the secondary voltage Vs, and the reactor current I_{L}. The carrier frequency setting unit 14 outputs a frequency designation signal X6 indicating the carrier frequency fc to the adder 16.

The random number generation unit 15 is a random number generator that generates any integer as a random number X7. The random number generation unit 15 generates the random number X7 under a generation range and a generation condition, which are set in advance. The generation range is in a range of −200 to +200.

The generation condition is a difference between a random number yₙ, which is generated at a certain time point n, and a random number yₙ₊₁, which is generated at the next time point (n+1).

That is, the random number generation unit 15 generates the random number yₙ₊₁ such that a difference between the random number yₙ₊₁ and the random number yₙ exceeds a threshold value Y that is set in advance. The random number yₙ₊₁ at the time point (n+1) is an integer having a deviation exceeding the threshold value Y with respect to the random number yₙ at the time point n. The random number generation unit 15 generates the random number X7 that is dynamically changed in an integer range of −200 to +200, based on the generation range and the generation condition. The random number generation unit 15 outputs the random number X7 to the adder 16.

The adder 16 adds the random number X7 to the frequency designation signal X6 and outputs the result to the transformation gate signal generation unit 2a of the gate driver 2 as a carrier frequency manipulation signal X8. Since the carrier frequency manipulation signal X8 is obtained by adding the random number X7 to the frequency designation signal X6, the carrier frequency manipulation signal X8 is a time-series signal that is changed in a time series manner within the range of −200 Hz to +200 Hz with the carrier frequency fc (kHz) as the center.

The carrier frequency manipulation signal X8 defines the repetition frequencies of the first to fourth transformation gate signals in the transformation gate signal generation unit 2a that generates the first to fourth transformation gate signals (the PWM signals). Since the first to fourth transformation gate signals control the switching operation of the buck-boost converter D1, the carrier frequency manipulation signal X8 consequently influences a switching frequency and a switching timing in the switching operation of the buck-boost converter D1.

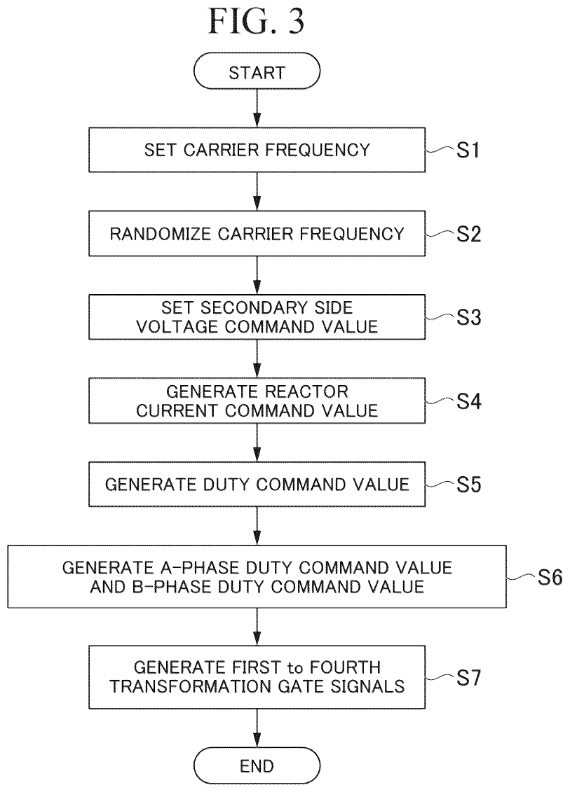

Next, a main unit operation of the power conversion device A according to the present embodiment, that is, a control operation of the transformation control unit B will be described with reference to the flowchart in FIG. 3.

In the transformation control unit B, first, the carrier frequency setting unit 14 generates the frequency designation signal X6 by acquiring the primary voltage Vp, the secondary voltage Vs, and the reactor current I_{L} (step S1). The carrier frequency setting unit 14 sets the carrier frequency fc by searching for the carrier map using the secondary voltage Vp, the secondary voltage Vs, and the reactor current I_{L} and outputs the frequency designation signal X6 indicating the carrier frequency fc to the adder 16.

The carrier frequency fc (kW) is randomized in the range of −200 Hz and +200 Hz by adding the frequency designation signal X6 with the random number X7 in the adder 16 (step S2). That is, by adding the random number X7, which is within the range of −200 and +200 generated by the random number generation unit 15, to the carrier frequency fc (kHz) in the adder 16, the carrier frequency manipulation signal X8 is generated that is changed in a time series manner within the range of −200 Hz and +200 Hz with the carrier frequency fc (kHz) as the center.

On the other hand, in the transformation control unit B, the target value setting unit 10 sets the secondary side voltage command value X1 by fetching the control command X0 (step S3). The secondary side voltage command value X1 is output from the target value setting unit 10 to the voltage control unit 11.

In the transformation control unit B, the voltage control unit 11 sets the reactor current command value X2 by fetching the secondary side voltage command value X1 and the secondary voltage Vs (step S4). The reactor current command value X2 is output from the voltage control unit 11 to the current control unit 12.

In the transformation control unit B, the current control unit 12 sets a duty command value X3 by fetching the reactor current command value X2 and the reactor current I_{L} (step S5). The duty command value X3 is output from the current control unit 12 to the duty control unit 13.

In the transformation control unit B, the duty control unit 13 generates an A-phase duty command value (manipulation amount) X4 and a B-phase duty command value (manipulation amount) X5 by fetching the duty command value X3 (step S6). The A-phase duty command value X4 and the B-phase duty-command value X5 are output from the duty control unit 13 to the transformation gate signal generation unit 2a of the gate driver 2.

The transformation gate signal generation unit 2a generates the first to fourth transformation gate signals by fetching the A-phase duty command value X4, the B-phase duty command value X5, and the frequency designation signal X8 from the transformation control unit B (step S7). The buck-boost converter D1 performs a desired buck-boost operation by outputting the first to fourth transformation gate signals from the transformation gate signal generation unit 2a to the buck-boost converter D1

Here, the frequency designation signal X8 is a manipulation amount for randomly setting the repetition frequencies (the repetition periods) of the first to fourth transformation gate signals in a time series manner. The first to fourth transformation gate signals, which are generated based on the frequency designation signal X8, are changed in a time series manner within the range of +200 Hz with respect to a center frequency.

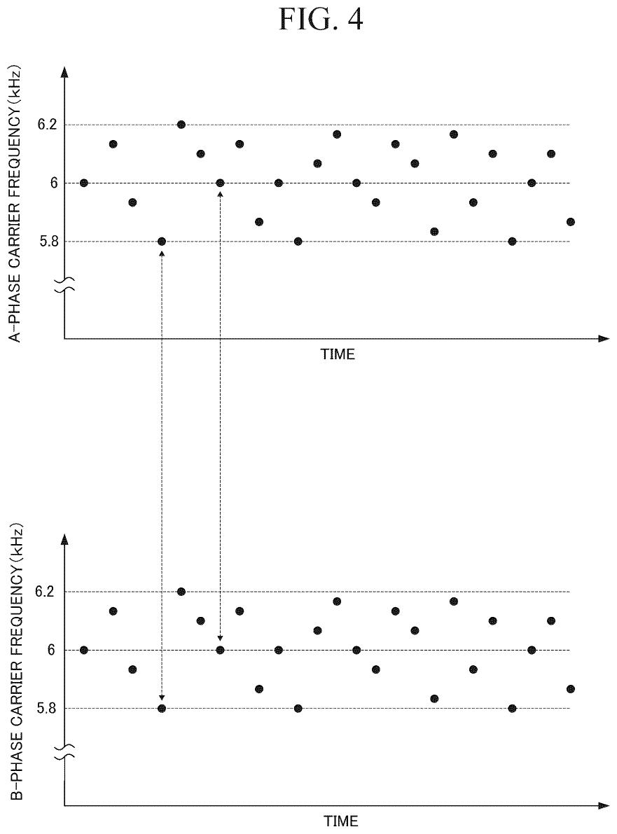

That is, when the carrier frequency fc, which is set by the carrier frequency setting unit 14, is 6 kHz, the carrier frequency in the A-phase of the buck-boost converter D1 (the A-phase carrier frequency) and the carrier frequency in the B-phase of the buck-boost converter D1 (the B-phase carrier frequency) are randomly changed between 5.8 kHz to 6.2 kHz, as shown in FIG. 4, for example.

Further, the A-phase carrier frequency and the B-phase carrier frequency are changed in synchronization with each other and are set to the same value. That is, as shown by a dashed line in FIG. 4, a change timing of the A-phase carrier frequency and the B-phase carrier frequency is the same, and when focusing on a certain time point, the A-phase carrier frequency and the B-phase carrier frequency are the same frequency.

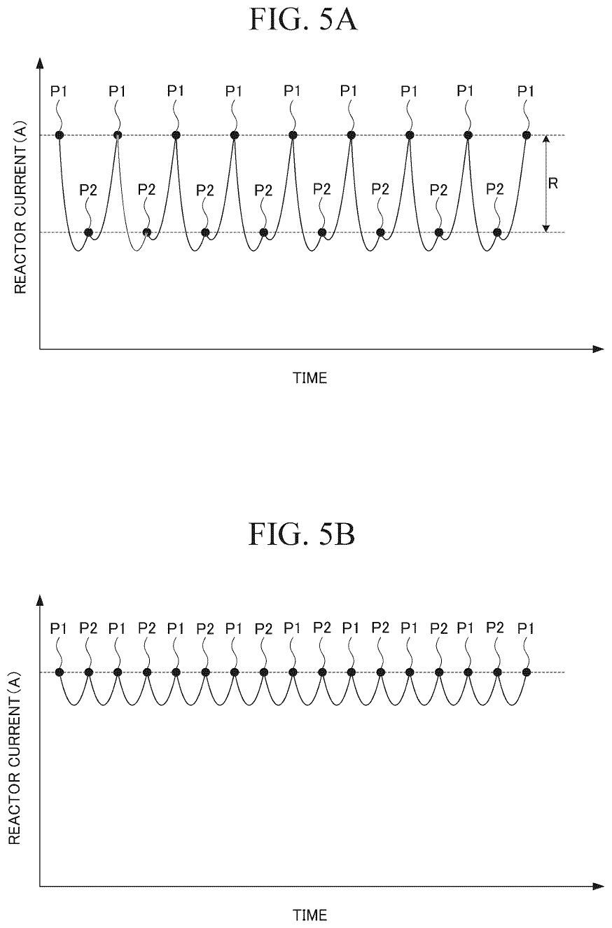

Among the first to fourth transformation gate signals, since the first and second transformation gate signals and the third and fourth transformation gate signals have a phase difference of 180°, in the buck-boost converter D1, the A-phase transformation switching leg and the B-phase switching leg perform switching operations with a phase difference of 180°. As a result, the A-phase current and the B-phase current become currents that have ripples having different phases, for example, as shown in FIGS. 5A and 5B.

In FIGS. 5A and 5B, the reference sign P1 is a peak point caused by the ripple of the A-phase current, and the reference sign P2 is a peak point caused by the ripple of the B-phase current.

Since the reactor current I_{L}, which is detected by the reactor current sensor J, is a total current of the A-phase current and the B-phase current, as shown in the figure, the reactor current I_{L} has a ripple waveform in which the ripples of the A-phase current and the ripple of the B-phase current are combined.

The peak point P1 and the peak point P2 are in a relationship in which the A-phase transformation switching leg and the B-phase switching leg perform switching operations with a phase difference of 180°, and the peak point P1 and the peak point P2 occur alternately on a time axis as shown in the figure.

In the reactor current I_{L}, when a deviation (a drift) occurs between the A-phase current and the B-phase current and the reactor L is changed with the current (the current superposition characteristics), the peak point P1 and the peak point P2 are at different levels as shown in FIG. 5A. On the other hand, when no deviation (drift) occurs between the A-phase current and the B-phase current, the peak point P1 and the peak point P2 are at the same level as shown in FIG. 5B.

The drift between the A-phase current and the B-phase current occurs when the ripple frequency of the load current of the travel motor M and the repetition frequency of the first to fourth transformation gate signals (the gate pulses) that control the buck-boost converter D1 (the magnetic coupling interleave type chopper circuit), that is, the carrier frequency fc are synchronized. The drift causes deterioration of the controllability of the buck-boost converter D1 or abnormal heat generation of devices such as the transformation IGBTs 6a to 6d in the buck-boost converter D1.

With respect to the drift between the A-phase current and the B-phase current, the transformation control unit B randomizes the carrier frequency fc (the frequency designation signal X6), which is set by the carrier frequency setting unit 14 by using the adder 16, by using the random number X7 generated by the random number generation unit 15. The transformation control unit B outputs a carrier frequency manipulation signal X8, which is randomly changed in the range of −200 Hz and +200 Hz with the carrier frequency fc (kHz) as the center, to the transformation gate signal generation unit 2a.

As a result, the transformation gate signal generation unit 2a generates the first to fourth transformation gate signals, of which repetition frequency is changed randomly within the range of −200 Hz and +200 Hz with the carrier frequency fc (kHz) as the center, according to the carrier frequency manipulation signal X8 and drives the buck-boost converter D1.

According to the transformation control device according to the present embodiment, it is possible to prevent synchronization with the ripple frequency of the load current of the travel motor M and the repetition frequencies of the first to fourth transformation gate signals that control the buck-boost converter D1. Therefore, according to the present embodiment, it is possible to provide a transformation control device and a power conversion device capable of suppressing the drift between the A-phase current and the B-phase current in the buck-boost converter D1.

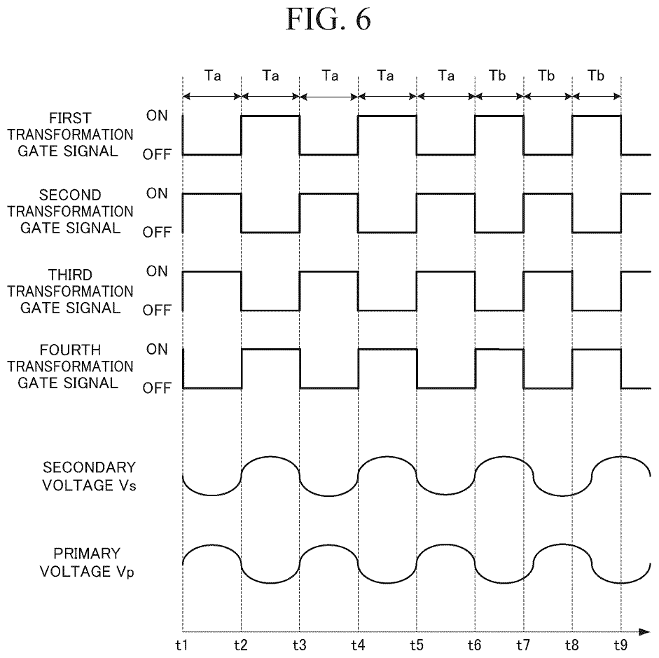

FIG. 6 shows a relationship between the first to fourth transformation gate signals, the primary voltage Vp, and the secondary voltage Vs. In a case where the repetition period is Ta, when the A-phase is focused, the primary voltage Vp is increased, and the secondary voltage Vs is decreased at the timing when the second transformation gate signal is “ON”. As a result, the A-phase current is increased.

Similarly, in a case where the repetition period is Ta, when the B-phase is focused, the primary voltage Vp is decreased, and the secondary voltage Vs is increased at the timing when the fourth transformation gate signal is “ON”. As a result, the B-phase current is decreased. Therefore, in a case where the repetition period is Ta, the A-phase current tends to be larger than the B-phase current.

In contrast, in a case where the repetition period is Tb, a magnitude relationship between the primary voltage Vp and the secondary voltage Vs at the ON timing of the second and fourth transformation gate signals as in the case where the repetition period is Ta, is reduced. As a result, the drift of the A-phase current and the B-phase current is suppressed. That is, it is possible to suppress the drift of the A-phase current and the B-phase current by simultaneously changing the ON timing of the A-phase second transformation gate signal and the B-phase fourth transformation gate signal to the same frequency.

Further, the invention is not limited to the above-mentioned embodiment. For example, the following modification examples are considered.
(1) In the above-mentioned embodiment, although the buck-boost converter D1, that is, the magnetic coupling interleave type chopper circuit having a configuration of two phases of the A-phase and the B-phase has been described, the present invention is not limited to this. That is, the present invention can also be applied to a magnetic coupling interleave type chopper circuit having a configuration of three or more phases.
(2) In the above embodiment, although the drift of the A-phase current and B-phase current is suppressed by driving the buck-boost converter D1 using the first to fourth transformation gate signals of which the repetition frequency is changed randomly within the range of −200 Hz and +200 Hz with the carrier frequency fc (kHz) as the center, the present invention is not limited to this.

The change in the repetition frequencies (the repetition periods) of the first to fourth transformation gate signals does not necessarily have to be random, and the change may be performed with some regularity.
(3) In the above embodiment, although a change width of the carrier frequency fc is set to ±200 Hz, the present invention is not limited to this. That is, the change width of the carrier frequency fc is appropriately set in consideration of the overall controllability of the buck-boost converter D1.
(4) Although not provided in the above embodiment, a duty correction unit may be provided that detects the drift of the A-phase current and the B-phase current based on the reactor current I_{L} and that adjusts a duty ratio of the A-phase first and second transformation gate signals or the B-phase third and fourth transformation gate signals according to the magnitude of the drift.

According to the duty correction unit, it is possible to equalize time intervals between the peak points P1 and the peak points P2 that are arranged alternately on the time axis by adjusting the duty ratio in the A-phase or B-phase switching operation. As a result, it is possible to improve the detection accuracy of the drift.
(5) In the above embodiment, although the switching frequency is set by setting the carrier frequency fc and randomizing the carrier frequency fc based on the primary voltage Vp, the secondary voltage Vs, and the reactor current I_{L}, which are the state quantities of the buck-boost converter D1 (the magnetic coupling interleave type chopper circuit) in the carrier frequency setting unit 14, the present invention is not limited to this. For example, the switching frequency may also be set by setting the carrier frequency fc based on a transformation ratio obtained from the primary voltage Vp and the secondary voltage Vs and randomizing the carrier frequency fc.
(6) In the embodiment described above, although the total current of the A-phase current and the B-phase current is detected as the reactor current I_{L} by using the single reactor current sensor J, the invention is not limited to this. By providing two current sensors, the A-phase current and the B-phase current may be individually detected.
(7) In the embodiment, although the power conversion circuit 1, which uses the IGBT as the semiconductor switching element, has been described, the present invention is not limited to this. As the semiconductor switching element, for example, a MOSFET may be employed.

### INDUSTRIAL APPLICABILITY

The present disclosure can be used for a transformation control device and a power conversion device.

### REFERENCE SIGNS LIST

A: Power conversion device
B: Transformation control unit
D1: Buck-boost converter (Magnetic coupling interleave type chopper circuit)
D2: Drive inverter
D3: Power generation inverter
E1, E2: Battery terminal
Fu, Fv, Fw: Motor terminal
G: Power generator (Rotary electric machine)
Hu, Hv, Hw: Power generator terminal
J: Reactor current sensor
P: Battery
M: Traveling motor (Rotary electric machine)
1: Power conversion circuit
2: Gate driver
2a: Transformation gate signal generation unit
2b: Drive gate signal generation unit
2c: Power generation gate signal generation unit
3: Electronic control unit (ECU)
4: First capacitor
5: Transformer
5a: Primary winding
5b: Secondary winding
6a to 6d: Transformation IGBT
7: Second capacitor
8a to 8f: Drive IGBT
9a to 9f: Power generation IGBT
10: Target value setting unit
11: Voltage control unit
12: Current control unit
13: Duty control unit
14: Carrier frequency setting unit
15: Random number generation unit
16: Adder

1. A transformation control device that controls a magnetic coupling interleave type chopper circuit, the transformation control device comprising:
a switching frequency setting unit configured to change a switching frequency of the magnetic coupling interleave type chopper circuit in a time series manner within a predetermined frequency range, wherein
the transformation control device generates a transformation gate signal having the switching frequency and outputs the transformation gate signal to the magnetic coupling interleave type chopper circuit.

2. The transformation control device according to claim 1, wherein
the switching frequency setting unit is configured to randomly change the switching frequency.

3. The transformation control device according to claim 1, wherein
the switching frequency setting unit is configured to set the switching frequency based on a state quantity of the magnetic coupling interleave type chopper circuit.

4. The transformation control device according to claim 1, wherein
a single current sensor acquires a reactor current of each phase and the switching frequency is set based on the reactor current.

5. The transformation control device according to claim 4, wherein
the current sensor detects the reactor current such that current-conduction directions are the same direction.

6. The transformation control device according to claim 1, wherein
the switching frequency setting unit is configured to set the switching frequency such that each phase of the magnetic coupling interleave type chopper circuit has the same frequency.

7. A power conversion device comprising:
the transformation control device according to claim 1;
the magnetic coupling interleave type chopper circuit configured to be controlled by the transformation control device;
a drive inverter that is provided between the magnetic coupling interleave type chopper circuit and a motor, that converts direct current power which is input from the magnetic coupling interleave type chopper circuit into alternating current power, and that outputs the alternating current power to the motor; and
a power generation inverter that is provided between the magnetic coupling interleave type chopper circuit and a power generator, that converts alternating current power which is input from the power generator into direct current power, and that outputs the direct current power to the magnetic coupling interleave type chopper circuit.
